(19) United States
(12) Patent Application Publication
(10) Pub. No.: US 2013/0319066 A1
(43) Pub. Date: Dec. 5, 2013

(54) Manufacturing System and Process Using a Laser Assisted Stamping Die

(71) Applicant: Jefferey W. Bennett, Hendersonville, TN (US)

(72) Inventor: Jefferey W. Bennett, Hendersonville, TN (US)

(21) Appl. No.: 13/487,659

(22) Filed: Jun. 4, 2012

(51) Int. Cl. B23K 26/42; B23P 17/00; B21D 43/28

(52) U.S. Cl. 72/338; 72/324; 29/592; 72/340

(57) ABSTRACT

A process and system for making a plurality of metal parts is included. The process comprises providing metal from which the metal parts are to be made and providing a press. The press includes a forming die positioned within the press as well as a first cutting laser positioned within the press. The process includes traversing the metal through the press and forming the plurality of metal parts in the metal within the press by concurrently cutting at least a portion of one of the plurality of metal parts with a first cutting laser and forming at least a portion of one of the plurality of metal parts with a forming die.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND OF THE INVENTION

The present invention relates generally to the production of parts. More specifically, the current invention relates to the use of a press to construct metal parts from metal material, including a strip or sheet of metal material.

Currently, the two dominant methods for manufacturing formed metal parts are stamping, or metal stamping, and fabrication. Both stamping and fabrication vary in their production methods and have distinct advantages and disadvantages over the other.

Metal stamping is the use of a press, which is typically mechanical or hydraulic in nature, to operate a die positioned in the press that both cuts and forms a part from the material, typically a strip or sheet of metal. This material is fed into the press and then into the die positioned therein. The die performs various manufacturing processes on the material as it traverses through the die. These processes can include cutting, such as punching, blanking, and trimming, and forming, such as embossing, bending, flanging, and drawing. Stamping can form parts from sheets or rolls of material, depending on the size of the part needed and the press and die employed.

Typically, in operation a stamping die has two halves attached to different sections of the press. Each stroke of the press—which is the movement of the two halves of the die from a separated position, to a closed position and then back to separated position—forms a portion of the finished part. On the separation of the two halves of the die, the material from which the part is formed is indexed forward to its next location and the halves of the die are then returned again to engage the metal material to form the next portion of the part. These types of dies are sometimes called progressive dies since the material is inserted in its raw form at one end in the die and with each stroke the part is progressively formed until a finished part is ready at the other side of the die.

Main characteristics of the metal stamping process include fast productions speeds once the die and press are set up and operational, expensive tooling and die costs, and lack of flexibility in implementing changes in the parts being produced. Stamping is most beneficial when large volumes of parts are needed with little to no changes in those parts. Stamping can have low labor costs due to the fact that once the die is set up in the press, and the press is running to make the parts, there is little labor involvement in its manufacture. However, conventional stamping has very expensive tooling and die costs that generally offset any low labor cost.

The formation of parts by conventional metal stamping has drawbacks. For example, a drawback to the stamping process is the cost to make and maintain the die. Dies used in conventional stamping are typically very intricate and complicated and, as a result, expensive to both create and maintain. Typically, parts made by these dies require an adherence to detailed tolerances. This results in the need for accuracy in the cutting portions of the die and continual maintenance of the die to keep the finished part/product within those tolerances. Stamping also has high repair costs due to these intricacies and the cost of skilled, trained labors required to create and maintain those dies. As such, the expense of creating, maintaining, and properly positioning these conventional dies in a press is large.

Typically, during the stamping process the cutting edges of the die are the aspects of the die that wear out first and need replacing and/or maintenance first. These include shear edge punches and the like. A large portion of the tooling costs with the dies revolves around the construction and maintenance of these cutting edges. Additionally, it is typical that before these cutting edges break or fail, the die produces parts outside of their acceptance tolerance ranges. Additionally, the shearing edges on traditional stamping dies create a burr along the cut line. This is best illustrated by FIG. 4. This burr and corresponding non-conformity in the area of the cut metal can cause complications depending on the intricacies of the parts being manufactured and the tolerances required for their specific use.

Another drawback to traditional stamping is the high material costs or waste associated with the process. This waste is typically caused by the actual manufacturing process and limitations in the cutting capabilities of these conventional dies. Other drawbacks to traditional stamping include the inflexibility to change the part or process and delays in the delivery of initial parts due to long lead times required to construct the die.

Fabrication is an industrial term that refers to creating metal parts by cutting, bending, and assembling. Fabrication typically involves multiple machines spaced about a production facility. The raw material used for the part is transported, either manually or by automation, from one machine to the next such that the various building processes are performed in the desired order by the individual machines. Various machines and/or processes are used to cut and bend metal into parts in fabrication. Cutting processes include sawing, shearing, punching and heat cutting (e.g. by torch, laser, and plasma cutters). Bending typically involves a press break bender. After cutting and bending, fabrication uses secondary forming and assembly process to finish the part.

The fabrication process typically begins with sheet metal but can include rolls of material as well. Typically, fabrication includes machines that are not specifically designed to make a particular part but can be adjusted to make aspects of numerous parts. For example, conventional fabrication uses lasers, (e.g. CNC machines), to cut, engrave, and otherwise remove a portion of the metal in the formation of a part. These CNC machines however are typically stand-alone pieces of equipment that are not part of another process, such as stamping or forming.

Fabrication is most effective when the volume of parts needed is small and those parts require multiple cutting and formation processes per individual part. The fabrication process has a large degree of flexibility built into the process since each machine is independent and can accept and operate on the part independently of the other machines in the process. The lack of dedicated hard tooling also adds to the flexibility of fabrication. Tooling used in fabrication can be used for more than one part, is simpler in design than that of stamping tooling, and can be altered to accommodate various part geometries. Fabrication can reduce the individual sunk costs into the building of each part (i.e. cost per part) by using multiple machines to make a wide variety of parts. However, fabrication typically has a high labor costs due to the setup times with each machine in the process, as well as the physical movement between machines of each part during production. Fabrication also is not very effective to create large number of parts due to the lack of dedicated machinery and tooling for a particular part.

Fabrication typically has a low material cost, as compared to stamping, due to the minimization of waste during the cutting processes in the creation of the part. However, fabrication does have comparably higher labor costs due to the multiple times the part is handled during transportation between machines and the slower rate of comparable operation. In some instances, fabrication uses automated material handling equipment to reduce the labor cost but these machines greatly increase the overall sunk equipment cost when utilized. Fabrication typically has a low tooling cost due to the fact that a single machine in the fabrication process can be used to make numerous parts by simply varying the setup of that machine to adapt to the next part needed.

As compared to fabrication, stamping typically becomes cost effective as the volume of the parts required per year increases or where complex forming is required. This is due to the sunk cost in the tooling and die creation and maintenance is extensive. For example, the price per part can level out as the volume of parts per year approach approximately 100,000. In fact, in some cases, as the volume of parts increases the price per part can drop substantially. This drop can be attributed to the amortization of the tooling costs over a greater total number of parts made within a given period of time. Additionally, the automated nature of stamping facilitates a lower price per part due to the higher rates of operation when compared to fabrication.

Conversely, the cost per part for a fabrication process stays fairly consistent throughout regardless of the volume of parts being created. This is typically due to the general process itself of fabrication does not lend itself to a volume discount realized as the production count of parts made per year increases. For example, typical fabrication has a generally stagnate price per part and this price varies little when the number of parts made per year ranges from as low as 1,000 or upwards of a million.

What is needed then is a new manufacturing process including a machine for accomplishing the same that draws strengths from both the stamping and fabrication processes. Preferably, this new production method includes some flexibility of fabrication while enjoying some of the economies of scales of stamping. Preferably this needed process can incorporate the production of a part within a single device, such as a press, to further reduce costs and the price per part made. This process and machine for the same are lacking in the art

### BRIEF SUMMARY OF THE INVENTION

Disclosed herein is a process for making a plurality of metal parts. The process comprises providing a press and a strip or sheet of metal from which the metal parts are to be made. The press includes a forming die positioned within the press as well as a first cutting laser positioned within the press. The process includes traversing the metal through the press and forming the plurality of metal parts in the metal within the press by concurrently cutting at least a portion of one of the plurality of metal parts with a first cutting laser and forming at least a portion of one of the plurality of metal parts with a forming die.

The process can include providing the press with multiple cutting lasers and multiple forming dies positioned within the press at various locations. In one embodiment, the process can further include providing the press with second and third cutting lasers positioned within the press with the forming die positioned between at least two of the first, second or third cutting lasers. The process can also include separating a part from the residual metal material, called a carrier, and discharging the completed part from the press.

The process can further include providing a press with a motion-controlled system operably attached to the press and the first cutting laser. The motion control system can position a first cutting laser relative to the metal such that the laser accurately cuts the metal as desired. The cutting of the metal parts can include laser machining openings, laser welding, laser marking or laser surface treating the metal part.

In a preferred embodiment, the movement of the metal and the forming of the part from the metal are continuously and sequentially performed steps.

It is therefore an object of the present disclosure to provide a new method of part formation.

Another object of the present disclosure is to provide a new method of manufacturing metal parts within a press.

Still another object of the present disclosure is a method of forming metal parts using a die and laser cutter positioned within a press.

Still another object of the present disclosure is to provide a method of forming a metal part that combines some of the flexibility of fabrication with some of the cost savings of the economy of scales of metal stamping within a single machine.

Other and further objects, features and advantages of the present disclosure will be readily apparent to those skilled in the art upon a reading of the following disclosure when taken in conjunction with the accompanying drawings.

### BRIEF DESCRIPTION OF THE SEVERAL VIEWS OF THE DRAWINGS

FIG. 1 is a flow chart of the process performed in accordance with the current disclosure.

FIG. 2 is a flow chart showing some additional steps of a forming process performed in accordance with the current disclosure.

FIG. 3A is a top partial cutaway illustration of a manufacturing process and system in accordance with the current disclosure.

FIG. 3B is side view of the manufacturing process using the system from FIG. 3A.

FIG. 4 is an illustration of the burr and deformities in a cut metal part using conventional metal stamping processes.

FIG. 5 is an illustration of an example of the inventive process.

FIG. 6 is a side schematic representation of a portion of a press used in accordance with the current disclosure and illustrating the inventive process.

FIG. 7 is a partial detail view of multiple laser cutting heads and their application in the inventive process to making a part in accordance with the current disclosure.

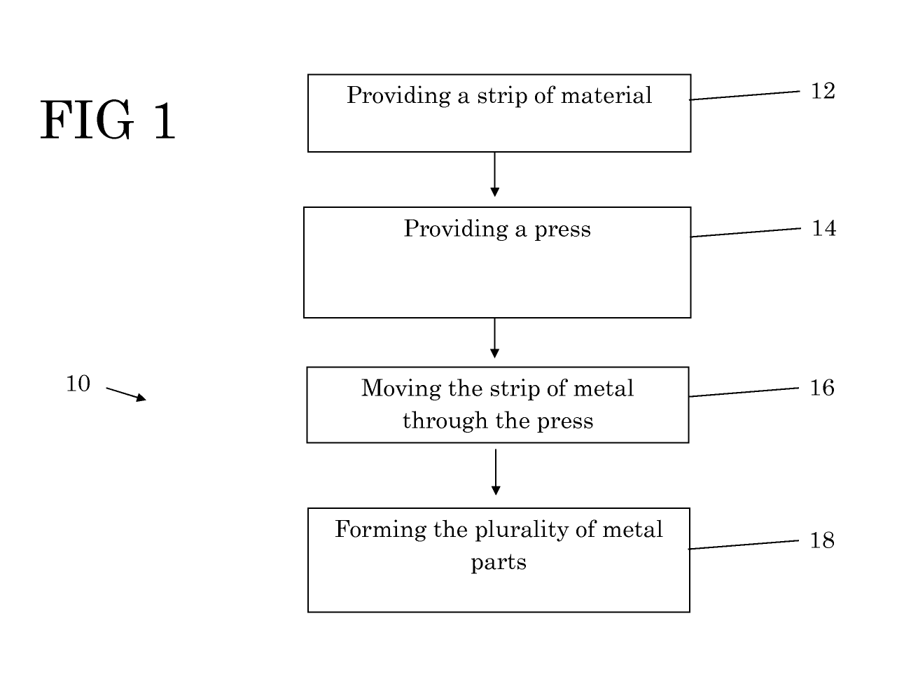

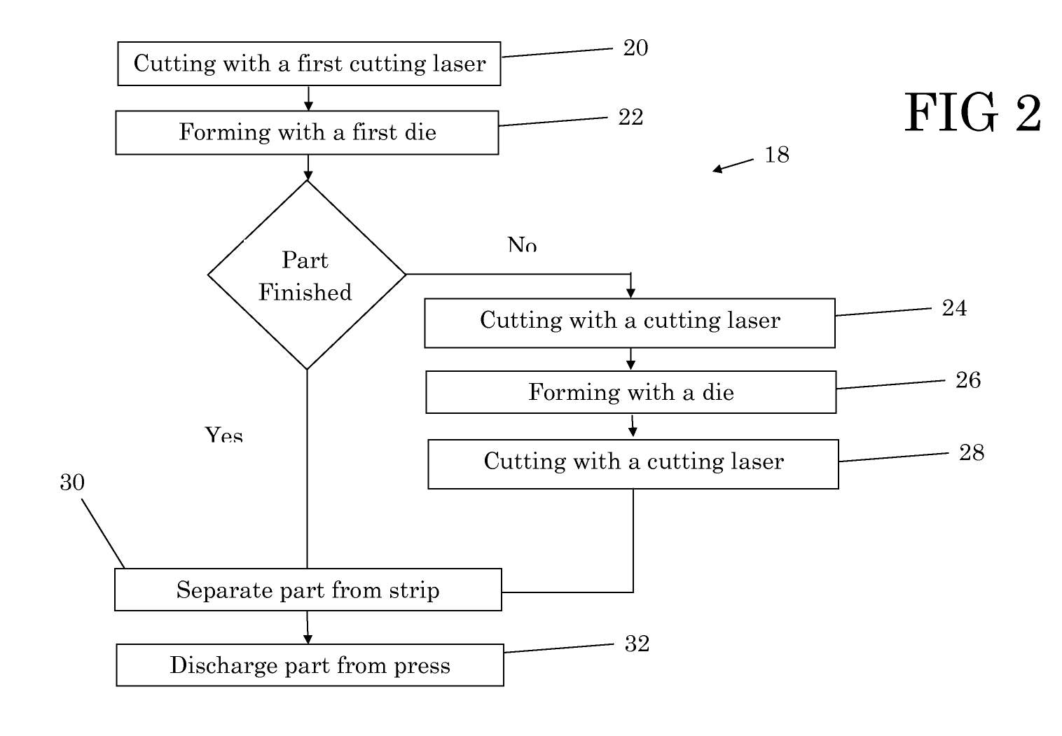

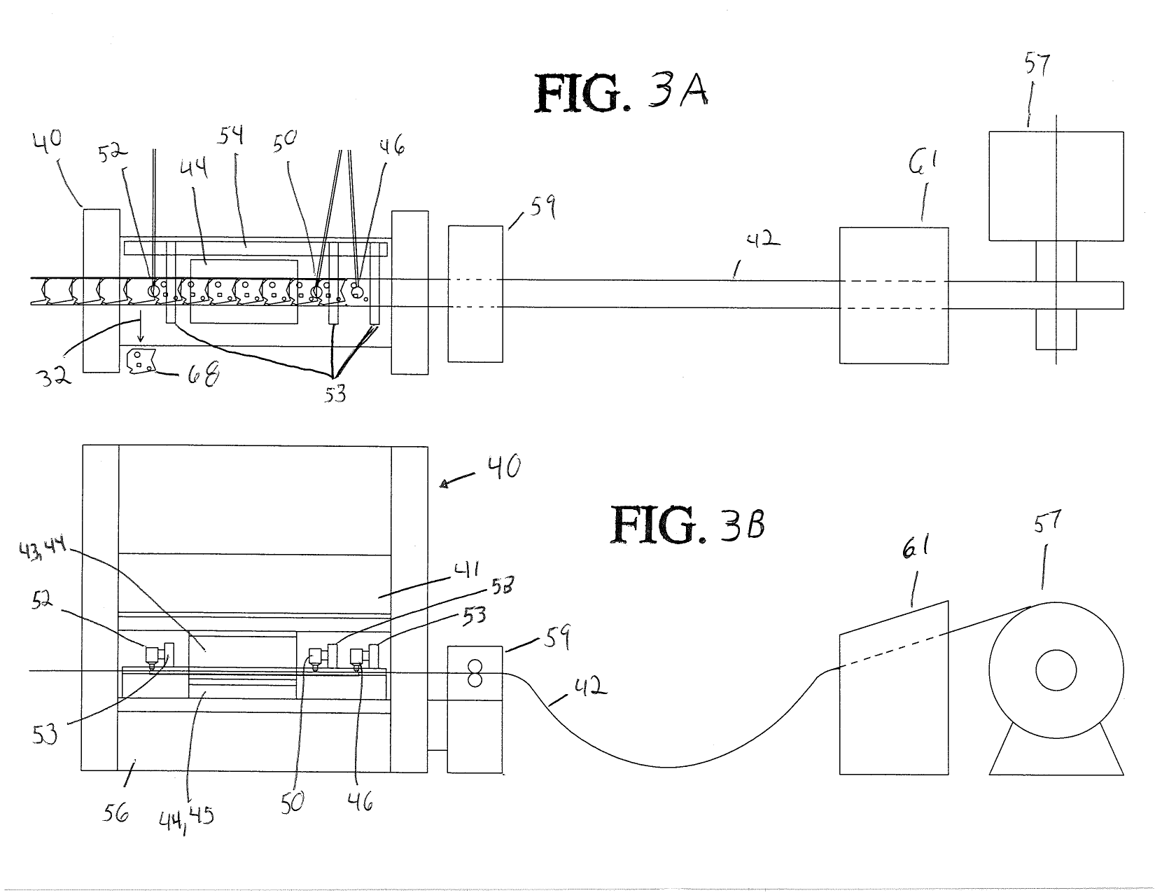

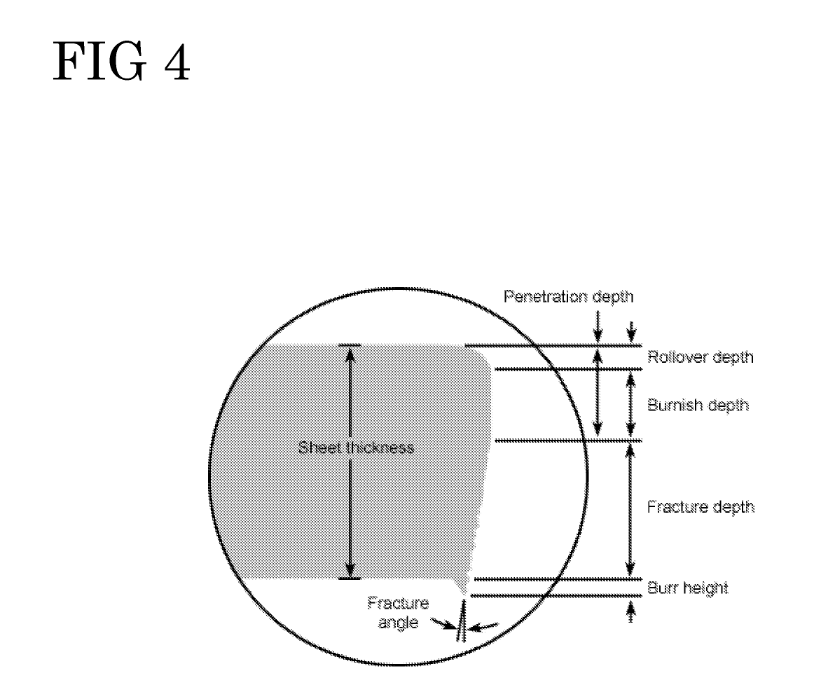

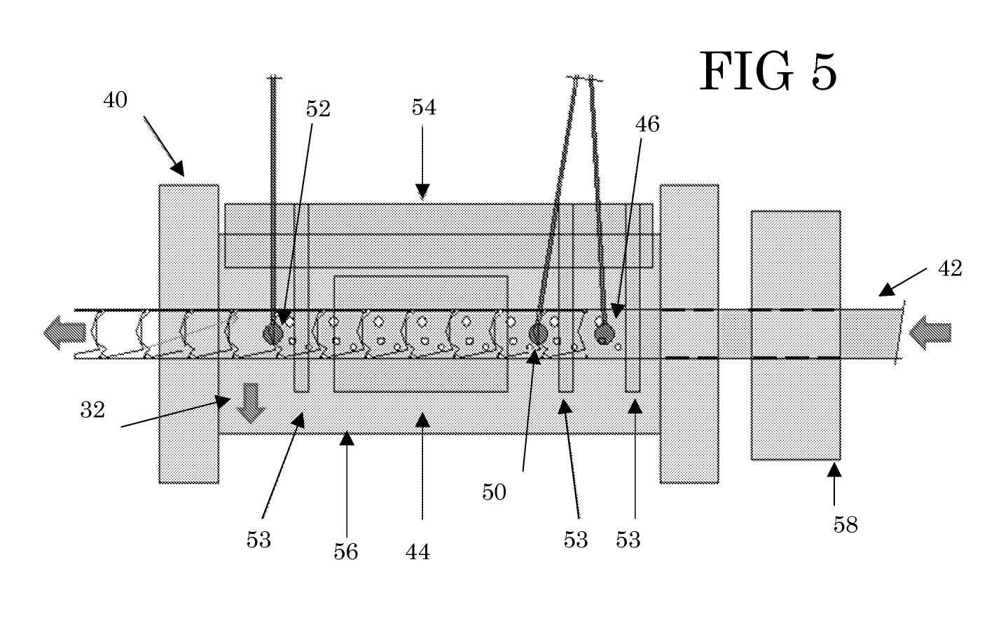

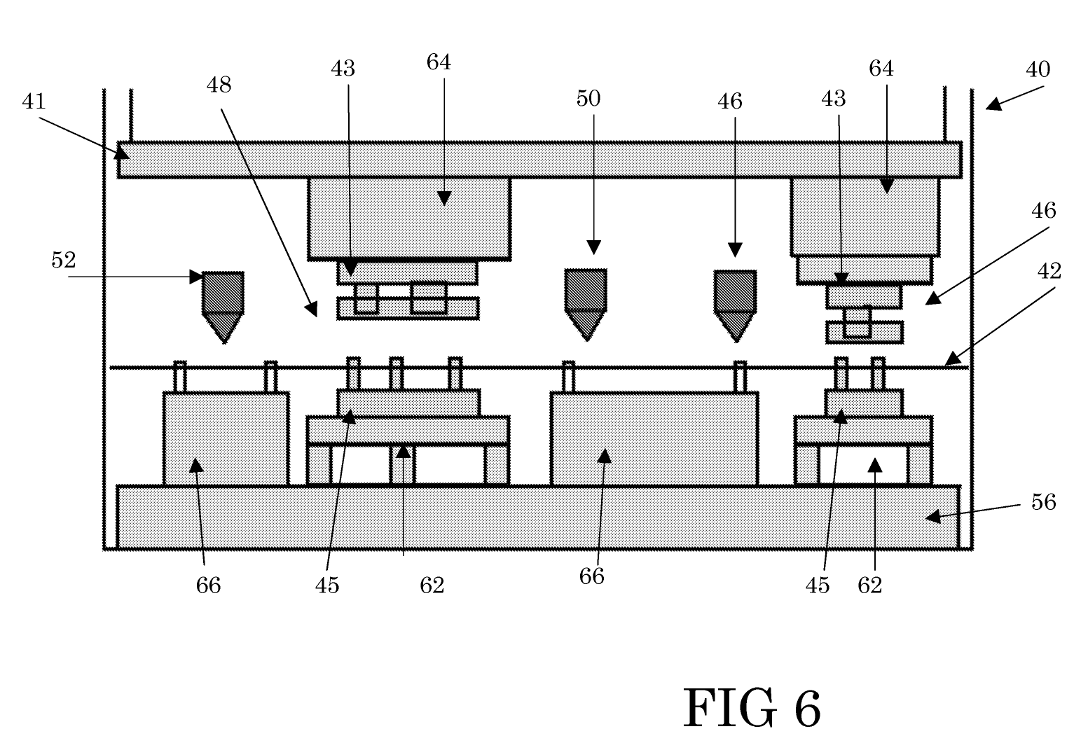

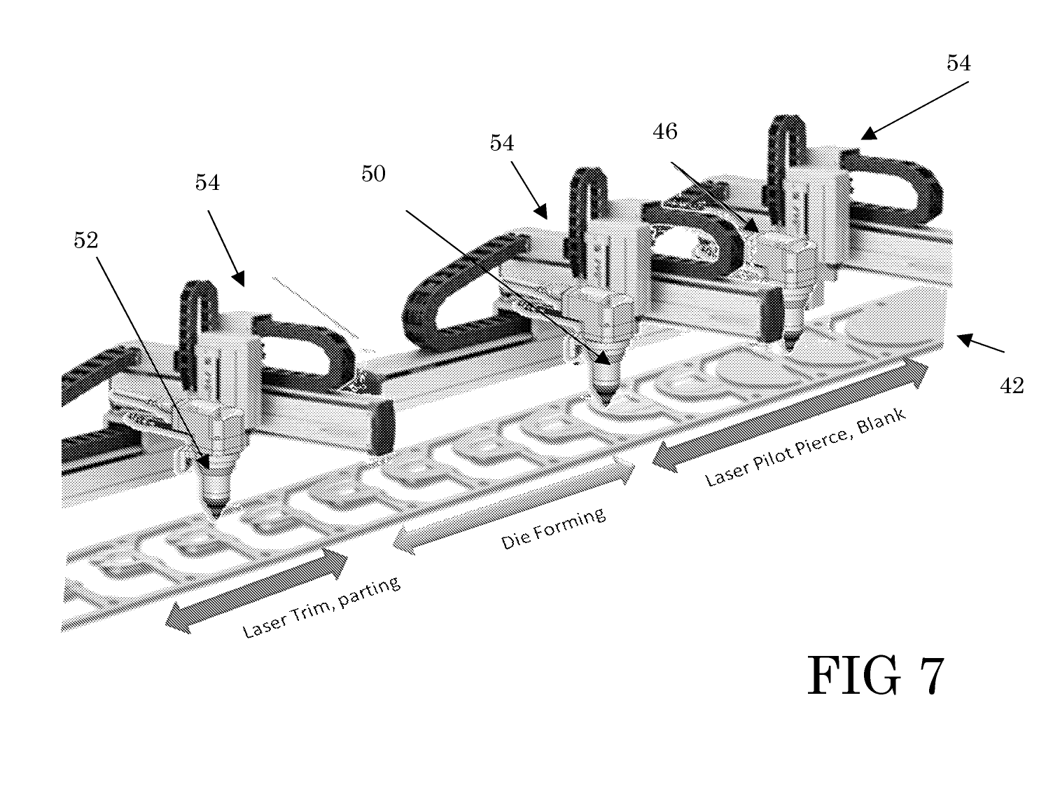

### DETAILED DESCRIPTION OF THE PREFERRED EMBODIMENTS

Referring generally to the Figures, a process for making a plurality of metal parts is generally shown in the flow chart as numeral 10. The process includes providing metal from which the metal parts are to be made, indicated by numeral 12, and providing a press, indicated by the numeral 14. The process further includes traversing the metal through the press, as indicated by numeral 16, and forming the plurality of metal parts, as indicated by numeral 18.

The step 18 of forming the metal parts further includes cutting at least one portion of the metal parts with a first cutting laser, as indicated by the numeral 20 and forming at least a portion of one of the parts with the forming die, as indicated by numeral 22. The process can further include cutting one or more of the parts with additional cutting lasers and additionally forming the part with an additional forming die as indicated by numerals 24, 26, and 28. The forming step 18 occurs within a press 40 such that the cutting and forming steps 20, 22, 24, 26, 28 as desired occur within the press. As such, the metal 42, which can come in various forms such as a strip or sheet, is fed into the press 40 and processed until the manufactured part exits the opposite end of the press 40. The process can further include separating a part from the residual metal material, as indicated by the numeral 30 and discharging the completed part from the press as indicated by the numeral 32.

In a normal cycle of operation, the material 42, preferably a strip or sheet of metal, is fed into the press 40. Various material handlers 58, such as feed lines, transfer automation, coil handling and feeding equipment and servo feed line machines as known in the art, can feed the material 42 into the press 40. These material handlers 58 can include a reel coil holder 57, a material straightener 59, and a material feeder 61. These machines can handle various thicknesses and widths of material including multiple rolls or coils of material.

The press 40 can be various types of presses known in the art. For example, the press 40 could be a hydraulic press as shown, or alternately, a mechanical press could be used. Various types of presses have the advantages that could be useful depending upon the particular part being made and facility in which the press forward is used.

Most presses will have a bed 56 upon which a portion of the forming die 44 and the first cutting laser 46 are operatively attached. A motion control system 54 can also be operably attached to the press 40, for example to the bed 56. The motion control system 54 can position the first cutting laser 46 in relationship to the metal 42 as it passes through the press 40 to properly cut the metal 42 into the part.

In operation, the operator of the press 40, with aid from the material handler 58, feeds the metal 42 into the press 40. Once the metal 42 is properly fed into the press 40, the operator can start the automated stroke of the press. The stroke of the press is the movement of the ram 41 as it closes and opens the die 44. Once the press is operational with the die positioned and the laser cutting programed, the first operation is preferably a cutting of the metal 42 by a first cutting laser 46. The press 40 and material handler 58 are sequenced such that each stroke coordinates an indexing and forward feed of the material 42 within the press 40. The first cutting laser 46 is preferably operably attached to the bottom of the bolster 56 such that the first cutting laser 46 does not move with the stroke of the press 40.

After the first cutting of the metal 42 by the first cutting laser 46, the metal 42 will index forward to engage into the next aspect of the part formation process. This location can include a forming die 44 or a second cutting laser 50. If it is a second cutting laser 50, the second cutting laser 50 will perform another cutting operation into the metal during the stroke of the press 40. If it is a forming die 44 the stroke of the press will move together two halves of a die 43 and 45 such that the internal portions of the forming die 44 will process the metal, such as bending that portion of the metal into a portion of the part as desired. Again, with each stroke of the press the metal will index forward such that the previous section of the metal 42 that was processed, such as cutting by the first cutting laser 46, will be processed by the next piece, such as forming by the forming die 44. As such, with two strokes of the press 40, a portion of the metal 42 could be both cut and formed. This process can continue with additional cutting lasers, such as a second cutting laser 50 or a third cutting laser 52, as well as additional forming dies, such as second forming die 48. Each stroke will index the metal carrier and the partially formed part forward through the die until the last operation is performed and the part is completed. At that time, the part can be discharged from the press 40.

Preferably, these operations are performed concurrently and sequentially, such that each stroke forms a completed part and various subparts, depending on the number of progressions within the press and its operating components. For example, once a press 40 with first, second and third cutting lasers 46, 50, and 52, and first and second forming dies 44 and 48 is up and operational, each stroke of that press 40 will create a completed part and multiple partially completed parts, with each partially completed part nearing the completed stage as in comparison to the just prior part forming location in the sequence of the press operation.

The current inventive operation and press could be effective to produce parts with annual quantities of parts of approximately 1,000 to 100,000. Optimal annual quantities for the process will vary and are dependent on the total of multiple cost factors including labor, materials, and tooling as compared to conventional stamping and fabrication methods for the same part. Various types of ferrous and non-ferrous materials can be used including steel, stainless steel, aluminum, brass, copper and others. The part sizes would generally depend upon the size of the press and the material width, wherein larger presses, and associated equipment such as material handlers, could accept larger material and produce larger part sizes. The process and system could be set up such that the rate of production is comparable to traditional stamping. This time could be reduced further depending upon the complexity of the part and the number of forming dies and cutting lasers used in the process and how those factors affect the press stroke time, feed length and required cutting per part.

Various types of lasers could be used. Preferably, lasers that have various beam strength and watt strengths are contemplated with the current disclosure. For example, fiber optic lasers of up to 6,000 watts could be utilized and various beam delivery methods could be used, including fiber optic, couplers, and splitters with various power supplies as warranted.

Various motion control systems 54 could be utilized with the current disclosure including Cartesian Robot as well as computer numerically controlled (CNC) software. Preferably, the control of the laser has positional capabilities in three different axes and uses armatures 53 to position the lasers. The CNC software could be used to control the robot armatures as known in the art. Traditional CAD or CAM software could be used to plan the project including the forming die portions.

Various alternate support technology could be used during this process including the use of quick die change technology which facilitates a loading positioning and clamping of a forming die onto a bolster—e.g. a magnetic bolster could be used to facilitate this process. Various sensors and automation could be used to facilitate the process and create a factor for safety within the process. These sensors can include buckle sensors, short feed sensors, part ejection and the like. Other sensors automation could include vision systems for inspections of the part during the manufacturing process. Other auxiliary equipment can include material handling and positioning systems, part conveyors, scrap conveyors, exhaust systems for the press and any ancillary equipment, and additional guarding and shielding to add a factor of safety into the process.

There are several advantages of the current process and system over traditional stamping and/or fabrication and result in a lowered total part cost for each part developed. For example, when compared to convention stamping process, the current inventive process can produce higher quality metal parts that can be produced at close to traditional stamping production rates. Additionally, the current process can minimize or avoid the high cost of dedicated tooling associated with conventional dies in the stamping process. Also, the part quality can be superior when compared to die cut parts that leave burr and malformed edges during their cutting processes. Additionally, with the laser cutting the amount of waste or scrap material can be reduced. This reduction can arise from the edge sharing in consecutive parts. Additionally, the reduction in tool and die costs realized by the simplification of the die used in the formation of the part also reduces the total part cost

When compared to traditional fabrication, the current inventive process and system can reduce setup times that will lower the costs and allow small part volumes to become practical and economically viable. This process and system reduces the handling and movement of parts between various machines present in the fabrication process. This results in an overall reduction in labor, lower cycle times, and reduced setup times

The current process reduces tool amortization, investment, lead-time and maintenance due to the reduction in the cutting features of the die used in this process to form the part. The operation of this current process should be faster than that of fabrication, have more flexibility, and be more cost efficient on a smaller volume of parts as compared to traditional stamping. This inventive process has the capability of fast changes in the actual part dynamics due to the controlled programmable laser cutting, which is in contrast to the difficulties of altering hard tooling systems in traditional stamping dies. The use of laser cutting also provides a superior part quality, especially in the burr free and square edges that are free from roll over and breakout typical of conventional punch and die cutting.

Thus, although there have been described particular embodiments of the present invention of a new and useful Manufacturing System and Process Using a Laser Assisted Stamping Die it is not intended that such references be construed as limitations upon the scope of this invention except as set forth in the following claims.

What is claimed is:

1. A process for making a plurality of metal parts, the process comprising:
providing metal from which the metal parts are to be made;
providing a press, the press including a forming die positioned within the press and a first cutting laser positioned within the press;
traversing the metal through the press; and
forming the plurality of metal parts in the metal within the press by concurrently cutting at least a portion of one of the plurality of metal parts with the first cutting laser and forming at least a portion of one of the plurality of metal parts with the forming die.

2. The process of claim 1, further including providing the press with a second cutting laser positioned within the press.

3. The process of claim 2, further including providing the press with a third cutting laser positioned within the press.

4. The process of claim 3, wherein the forming die is positioned between at least two of the first cutting laser, second cutting laser, or third cutting laser.

5. The process of claim 1, further including separating the part from the metal.

6. The process of claim 1, wherein the forming the metal part includes discharging a completed part from the press.

7. The process of claim 1, further including providing the press with a motion control system operably attached to the press and the first cutting laser.

8. The process of claim 7, wherein the motion control system positions the first cutting laser in relation to the metal.

9. The process of claim 1 wherein the cutting at least a portion of the metal part includes laser machining openings, welding, marking or surface treating the metal part.

10. The process of claim 1, wherein the traversing and forming steps are continuously and sequentially performed.

11. A process for making a metal part, the process comprising:
providing metal from which the metal part is to be made;
providing a press, the press including a forming die positioned within the press, a first cutting laser positioned within the press, and a second cutting laser positioned within the press;
moving the metal through the press; and
forming the metal part in the metal within the press by cutting at least a portion of the metal part with the first cutting laser, forming at least a portion of the metal part with the forming die, and cutting a different portion of the metal part with the second cutting laser.

12. The process of claim 11 further including providing the press with a third cutting laser positioned within the press, wherein the forming die is positioned between at least two of the first cutting laser, the second cutting laser, or the third cutting laser.

13. The process of claim 11 further including separating a completed part form the metal and discharging the completed part from the press.

14. The process of claim 11 further including providing the press with a motion control system operably attached to the press, the first cutting laser, and the second cutting laser, the motion control system positioning the first cutting laser and the second cutting laser in relation to the metal during operation of the press.

15. The process of claim 11 wherein the cutting at least a portion of the metal part includes laser machining openings, welding, marking or surface treating the metal part.

16. A process for making a metal part, the process comprising:
providing metal from which the metal part is to be made;
providing a press, the press including:
a forming die positioned within the press;
a first cutting laser positioned within the press;
a second cutting laser positioned within the press; and
a motion control system operably attached to the press, the first cutting laser, and the second cutting laser, the motion control system positioning the first cutting laser and the second cutting laser in relation to the metal during operation of the press;
moving the metal through the press; and
forming the metal part in the metal within the press by cutting at least a portion of the metal part with the first cutting laser, forming at least a portion of the metal part with the forming die, and cutting a different portion of the metal part with the second cutting laser.

17. The process of claim 16, wherein the forming of the metal part is sequentially performed during operation of the press and further includes separating the completed part from the press and discharging the completed part from the press.

18. The process of claim 16, wherein the cutting at least a portion of the metal part includes the steps of laser machining openings, welding, marking or surface treating the metal part.

19. The process of claim 16 further including providing the press with a third cutting laser positioned within the press, wherein the forming die is positioned between at least two of the first cutting laser, the second cutting laser, or the third cutting laser.
